(19) United States
(12) Patent Application Publication
(10) Pub. No.: US 2013/0218676 A1
(43) Pub. Date: Aug. 22, 2013

(54) Guaranteed Retargeting in Online Advertising

(71) Applicants: Matthew Ahrens, Champaign, IL (US); Greg Muchnik, Champaign, IL (US); Aaron J. Klish, St. Joseph, IL (US)

(72) Inventors: Matthew Ahrens, Champaign, IL (US); Greg Muchnik, Champaign, IL (US); Aaron J. Klish, St. Joseph, IL (US)

(73) Assignee: Yahoo! Inc., Sunnyvale, CA (US)

(21) Appl. No.: 13/399,580

(22) Filed: Feb. 17, 2012

(51) Int. Cl. G06Q 30/02

(52) U.S. Cl. 705/14.53

(57) ABSTRACT

The present invention provides techniques for use in advertising, including online advertising. Techniques are provided that include providing to advertisers guaranteed delivery advertisement retargeting, or contracts or agreements in guaranteed delivery advertisement retargeting. Techniques are provided that allow advertisers to purchase an anticipated set of advertisement impressions to a single user. The advertisement impressions may be of an identical advertisement or similar advertisements, and may be sequenced over time.

### BACKGROUND

“Advertisement retargeting”, “ad retargeting” and simply “retargeting” are terms in online advertising that include, after a user has been targeted with, and served, a particular advertisement, targeting the user with, and serving to the user, the same or a similar advertisement at a later time. Retargeting, generally, is known in online advertising. Through tracking a user and information about the user, such as by using cookie information, it may be determined that a particular user, with regard to whom an ad serving opportunity is available, has been served a particular ad at some point in the past. In a real-time or spot market advertising environment, for example, an advertiser may have a chance to bid for or purchase an ad serving opportunity that allows the same or a similar advertisement to be served to the particular user, which is an example of a ad retargeting. Multiple, time-spaced impressions of this sort can be effective, for example, in persuading a user to act on an advertisement, and so may be valuable to advertisers.

There is a need for additional or improved techniques in connection with advertisement retargeting.

### SUMMARY

Some embodiments of the invention provide systems and methods for use in advertising, including online advertising. In some embodiments, techniques are provided that include providing to advertisers guaranteed delivery advertisement retargeting, or contracts or agreements in guaranteed delivery advertisement retargeting. In some embodiments, techniques are provided that allow advertisers to purchase an anticipated set of advertisement impressions to a single user. In some embodiments, the advertisement impressions may be of an identical advertisement or similar advertisements, and may be sequenced over time.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

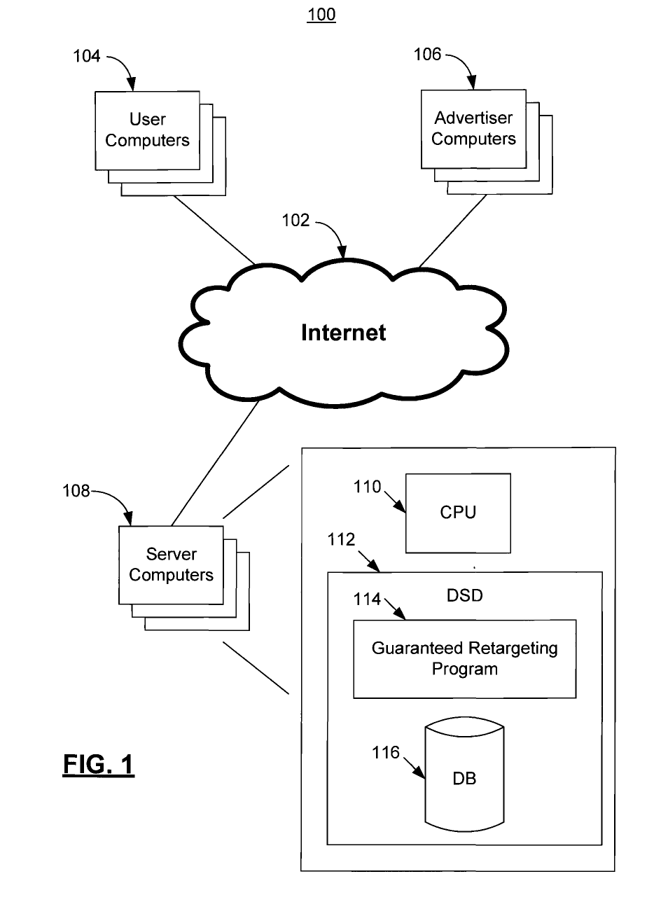

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Guaranteed Retargeting Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

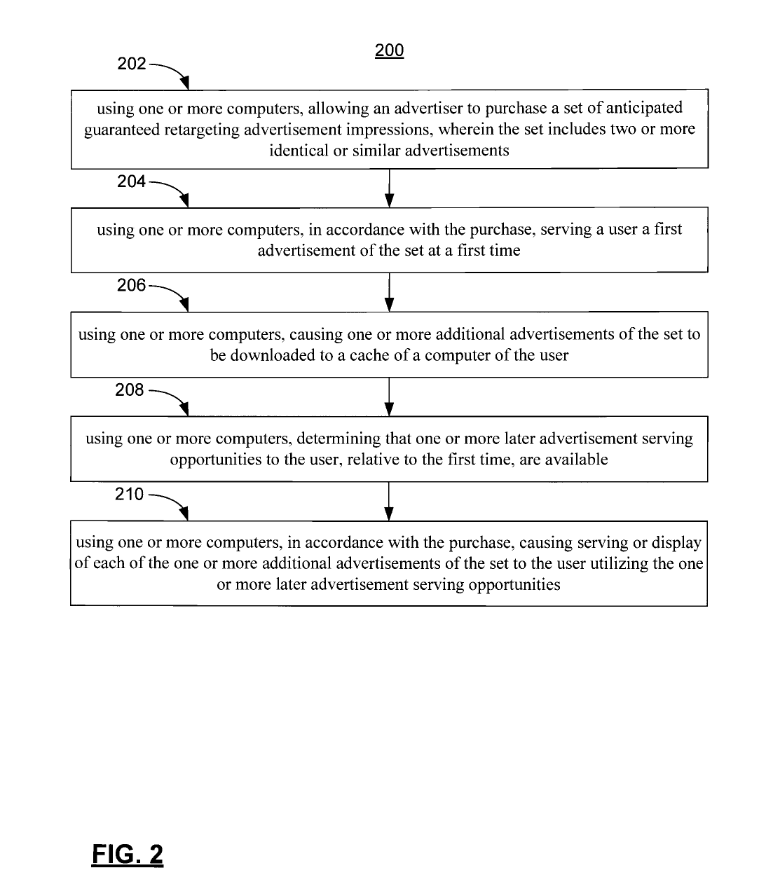

FIG. 2 is a flow diagram illustrating a method according to one embodiment of the invention. Step 202 includes, using one or more computers, allowing an advertiser to purchase a set of anticipated guaranteed retargeting advertisement impressions, wherein the set includes two or more identical or similar advertisements.

Step 204 includes, using one or more computers, in accordance with the purchase, serving a user a first advertisement of the set at a first time.

Step 206 includes, using one or more computers, causing one or more additional advertisements of the set to be downloaded to a cache of a computer of the user.

Step 208 includes, using one or more computers, determining that one or more later advertisement serving opportunities to the user, relative to the first time, are available.

Step 210 includes, using one or more computers, in accordance with the purchase, causing serving or display of each of the one or more additional advertisements of the set to the user utilizing the one or more later advertisement serving opportunities.

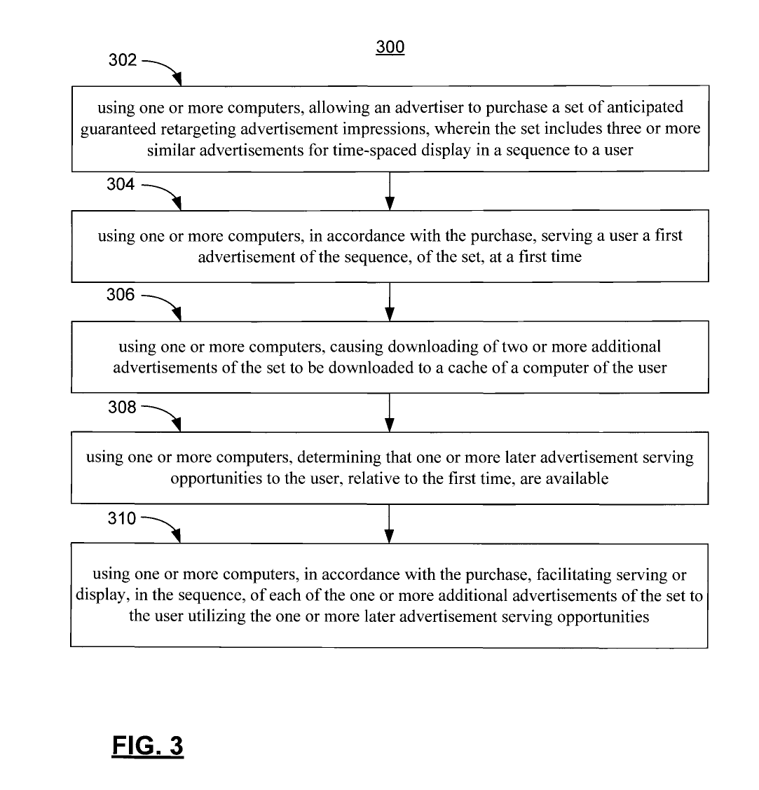

FIG. 3 is a flow diagram illustrating a method 300 according to one embodiment of the invention.

Step 302 includes, using one or more computers, allowing an advertiser to purchase a set of anticipated guaranteed retargeting advertisement impressions, wherein the set includes three or more similar advertisements for time-spaced display in a sequence to a user.

Step 304 includes, using one or more computers, in accordance with the purchase, serving a user a first advertisement of the sequence, of the set, at a first time.

Step 306 includes, using one or more computers, causing downloading of two or more additional advertisements of the set to be downloaded to a cache of a computer of the user.

Step 308 includes, using one or more computers, determining that one or more later advertisement serving opportunities to the user, relative to the first time, are available.

Step 310 includes, using one or more computers, in accordance with the purchase, facilitating serving or display, in the sequence, of each of the one or more additional advertisements of the set to the user utilizing the one or more later advertisement serving opportunities.

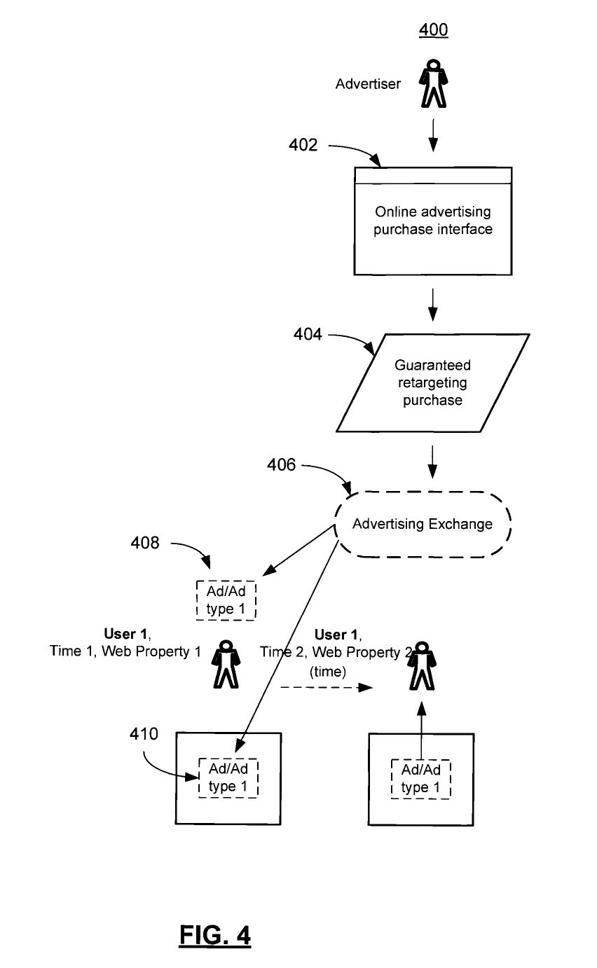

FIG. 4 is a block diagram 400 illustrating one embodiment of the invention.

An advertiser is depicted, utilizing an online advertising purchase interface 402, through which the advertiser makes a guaranteed retargeting purchase 404.

Upon occurrence of an advertising opportunity, or a suitable advertising opportunity, an advertising exchange 406, or other advertising system, including one or more components thereof, such as one or more server computers, is utilized in serving an advertisement, ad 1 408, to a user, user 1, at time 1 and while the user is visiting Web property 1. Furthermore, the same ad as ad 1 or a similar ad, represented by block 410, is caused to be downloaded to a cache of a computer of the user.

In some embodiments, a first ad is considered similar to a second ad if the first ad advertises the same one or more products, services, items, or brands as the first ad, or if the second ad advertises one or more products, services, or items that are in the same related group of products, services or items as one or more products, items or services advertised by the first ad.

At a later time, time 2, while the user may be visiting a different Web property, Web property 2, upon occurrence of an advertising opportunity, or a suitable advertising opportunity, the advertising exchange, or one or more components thereof, such as one or more server computers, are utilized in facilitating causing serving or display of the advertisement that is identical to or similar to ad 1, thus effectively retargeting the user, in accordance with the guaranteed retargeting purchase.

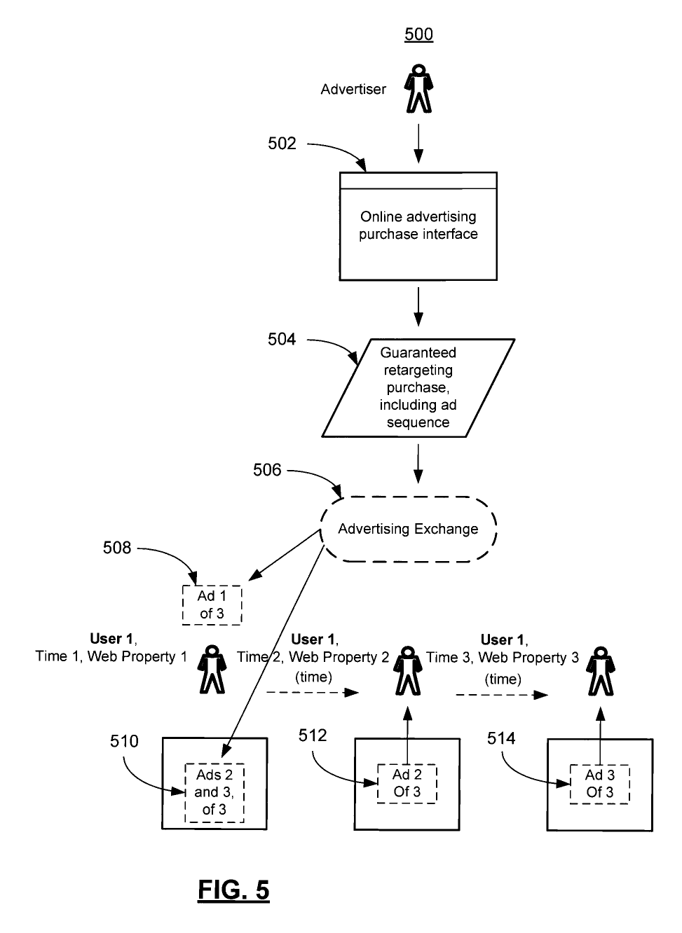

FIG. 5 is a block diagram 500 illustrating one embodiment of the invention. Block 502 represents an online advertising purchase user interface. Block 504 represents a guaranteed retargeting purchase, which includes a sequence of advertisement impressions.

Upon occurrence of an advertising opportunity, or a suitable advertising opportunity, an advertising exchange 506, or other advertising system, including one or more components thereof, such as one or more server computers, is utilized in serving an advertisement, ad 1 of 3 508, of a sequence of ads, to a user, user 1, at time 1 and while the user is visiting Web property 1. Furthermore, ads 2 of 3 and 3 of 3, of the sequence, represented as blocks 512 and 514, respectively, together represented by block 510, are caused to be downloaded to a cache of a computer of the user.

As depicted, ad 1 508, ad 2 512, and ad 3 514 are similar to each other.

At a later time, time 2, while the user may be visiting a different Web property, Web property 2, upon occurrence of an advertising opportunity, or a suitable advertising opportunity, the advertising exchange, or one or more components thereof, such as one or more server computers, are utilized in facilitating causing serving or display of the ad 2 of 3 512 of the sequence to the user. Furthermore, at a still later time, time 3, upon occurrence of an advertising opportunity, or a suitable advertising opportunity, the advertising exchange, or one or more components thereof, such as one or more server computers, are utilized in facilitating causing serving or display of the ad 3 of 3 514 of the sequence to the user. As such, the user had been effectively retargeted, utilizing a sequence of similar advertisements.

Some embodiments provide techniques for use in guaranteed delivery advertising. Guaranteed delivery formats may be different that spot market auction formats. For example, a spot market auction format may be used for real-time or spot market matching and pricing, which may include determination of ranking, of particular advertisements with particular serving opportunities, leading to serving and impressions.

In some embodiments, guaranteed delivery formats, as well as guaranteed delivery agreements or contracts, may be different than and not available in spot market auction formats. For example, in some embodiments, with such contracts, advertisers may obtain a guarantee of a certain number of impressions being provided, ahead of time, in accordance with specified targeting or other criteria, and at an agreed upon package price, to be delivered over a certain time period. While arrangements vary, if a guaranteed delivery contract is not fulfilled, the advertiser may obtain some benefit in return, such as a partial refund, reduction in price, alternative arrangements, etc.

In some embodiments, various means of tracking a user, such as for retargeting, are contemplated. For example, cookies, whether login-based or otherwise, may be utilized.

In some embodiments, advertisements are downloaded into a cache of a computer of a user, for later serving or display in connection with an appropriate opportunity. Various known possibilities are contemplated, which may include action of remote server computers operating in conjunction with a computer or browser of a user.

Some embodiments of the invention include a recognition that that advertisers have an interest in retargeting users, such as to illicit a specific response from the user, or to induce brand awareness and favorability, for example. Some embodiments of the invention allow for guaranteed retargeting through bulk ad sets, some or all of which may be sent to the user's browser and then caused to be displayed in ad spaces sequentially to optimally target the user. In some embodiments, this can allow for advantages such as faster or more instantaneous retargeting. In some embodiments, an up-front cost may be charged to the advertiser for such retargeting, or such retargeting contracts.

Some embodiments allow an advertiser to re-target a specific user with the same or similar ad. In some embodiments, this may be done in real-time or nearly real-time utilizing one or more ad servers. In some embodiments, techniques may include detecting and utilizing a user's frequency and recency profiles, such as through the user's cookie or cookies, and then allowing an advertiser to purchase a retargeted ad spot with that user.

In some embodiments, a system may be provided that includes components include an advertiser interface, one or more ad servers. A user's browser may operate in conjunction with the one or more ad servers. The advertiser interface may, for example, allow an advertiser to enter a cost or bid for retargeting for a particular type of user, and to upload a set of creatives or text advertisements that are included in the makeup of the retargeting campaign that will be applied for a targeted user. In some embodiments, when an ad call is made or facilitated by a browser and sent to the ad server, the ad server may, for example, choose the retargeted campaign entered by an advertiser, if it is applicable for the specific user, and send to the browser a set of advertisements, such as sequenced advertisements, in a particular order. The first advertisement would be rendered in conjunction with the user's browser, and the remaining advertisements may be cached. When another ad call was to be made or facilitated by the browser, a cache check may first be caused to be made, to check if there is an ad to be displayed from the retargeting campaign cache. If additional ads in the sequence are in the cache, the remaining ads may be rendered, such as in sequence. This may continue until all the ads in the retargeting campaign sequence are exhausted from the cache.

In some embodiments, advertisers may be allowed to specify certain criteria for the sequencing of the display of the ads. For example, an advertiser might specify that the sequence of ads should be shown at least five minutes apart. Another example might be that the first two ads in the sequence should be shown together if possible. Such rules may have to be enforced and implemented utilizing involvement of the ad server working in conjunction with the browser.

In some embodiments, techniques are provided that allows for retargeting to be purchased up-front for a user or targeted user or user type.

In some embodiments, a sequenced set of similar ads are contemplated. For example, ads of increasing urgency or aggressiveness may be utilized, in which the first ad just exposes a user to or brings to mind a brand or product, the second ad promotes the brand or product, and the third ad provides a discount for immediate purchase, etc. Of course, many other forms of sequencing and sequencing strategies may be utilized.

While the invention is described with reference to the above drawings, the drawings are intended to be illustrative, and the invention contemplates other embodiments within the spirit of the invention.

1. A method comprising:
using one or more computers, allowing an advertiser to purchase a set of anticipated guaranteed retargeting advertisement impressions, wherein the set includes two or more identical or similar advertisements;
using one or more computers, in accordance with the purchase, serving a user a first advertisement of the set at a first time;
using one or more computers, causing one or more additional advertisements of the set to be downloaded to a cache of a computer of the user;
using one or more computers, determining that one or more later advertisement serving opportunities to the user, relative to the first time, are available; and
using one or more computers, in accordance with the purchase, facilitating causing serving or display of each of the one or more additional advertisements of the set to the user utilizing the one or more later advertisement serving opportunities.

2. The method of claim 1, wherein the set comprising three or more advertisements for predetermined time-spaced sequential display to the user, and comprising causing serving or display of each of the three or more advertisements in sequential order.

3. The method of claim 1, wherein the set comprising three or more advertisements for predetermined time-spaced sequential display to the user, and comprising causing serving or display of each of the three or more advertisements in sequential order, and comprising allowing the advertiser to specify criteria relating to the sequential display.

4. The method of claim 1, comprising providing a graphical user interface through which the advertiser can make the purchase.

5. The method of claim 1, wherein the purchase is, or is part of, a guaranteed delivery advertising agreement or contract.

6. The method of claim 1, comprising allowing the advertiser to purchase the set, and wherein the set consists of identical advertisements.

7. The method of claim 1, comprising allowing the advertiser to purchase the set, and wherein the set consists of similar advertisements, wherein each of the advertisements in the set in similar in that each of the advertisements in the set advertises a particular brand, product or service, or one of a particular group of related products or services.

8. The method of claim 1, comprising allowing the advertiser to purchase the set, and wherein the set consists of similar advertisements, wherein each of the advertisement in the set is for the purpose of causing the user to make a purchase of a particular product or service, of the advertiser, or one of a particular group of related products or services, of the advertiser.

9. The method of claim 1, comprising tracking the user utilizing cookie information.

10. A system comprising:
one or more server computers coupled to a network; and
one or more databases coupled to the one or more server computers;
wherein the one or more server computers are for:
allowing an advertiser to purchase a set of anticipated guaranteed retargeting advertisement impressions, wherein the set includes two or more identical or similar advertisements;
in accordance with the purchase, serving a user a first advertisement of the set at a first time;
causing one or more additional advertisements of the set to be downloaded to a cache of a computer of the user;
determining that one or more later advertisement serving opportunities to the user, relative to the first time, are available; and
in accordance with the purchase, facilitating causing serving or display of each of the one or more additional advertisements of the set to the user utilizing the one or more later advertisement serving opportunities.

11. The system of claim 10, wherein at least one of the one or more server computers are coupled to the Internet.

12. The system of claim 10, wherein the set comprising three or more advertisements for predetermined time-spaced sequential display to the user, and comprising causing serving or display of each of the three or more advertisements in sequential order.

13. The system of claim 10, wherein the set comprising three or more advertisements for predetermined time-spaced sequential display to the user, and comprising causing serving or display of each of the three or more advertisements in sequential order, and comprising allowing the advertiser to specify criteria relating to the sequential display.

14. The system of claim 10, comprising providing a graphical user interface through which the advertiser can make the purchase.

15. The system of claim 10, wherein the purchase is, or is part of, a guaranteed delivery advertising agreement or contract.

16. The method of claim 10, comprising allowing the advertiser to purchase the set, and wherein the set consists of identical advertisements.

17. The system of claim 10, comprising allowing the advertiser to purchase the set, and wherein the set consists of similar advertisements, wherein each of the advertisement in the set is for the purpose of causing the user to make a purchase of a particular product or service, or one of a particular group of related products or services.

18. The system of claim 10, comprising allowing the advertiser to purchase the set, and wherein the set consists of similar advertisements, wherein each of the advertisement in the set is for the purpose of causing the user to make a purchase of a particular product or service, of the advertiser, or one of a particular group of related products or services, of the advertiser.

19. The system of claim 10, comprising tracking the user utilizing cookie information.

20. A computer readable medium or media containing instructions for executing a method comprising:
using one or more computers, allowing an advertiser to purchase a set of anticipated guaranteed retargeting advertisement impressions, wherein the set includes three or more similar advertisements for predetermined time-spaced display in a sequence to a user;
using one or more computers, in accordance with the purchase, serving a user a first advertisement of the sequence, of the set, at a first time;
using one or more computers, causing downloading of two or more additional advertisements of the set to be downloaded to a cache of a computer of the user;
using one or more computers, determining that one or more later advertisement serving opportunities to the user, relative to the first time, are available; and
using one or more computers, in accordance with the purchase, facilitating causing serving or display, in the sequence, of each of the one or more additional advertisements of the set to the user utilizing the one or more later advertisement serving opportunities.
